(19) United States
(12) Patent Application Publication
(10) Pub. No.: US 2008/0032707 A1
(43) Pub. Date: Feb. 7, 2008

(54) MOBILE PHONE SIGNAL STRENGTH INDICATOR

(76) Inventors: KULVIR SINGH BHOGAL, Fort Worth, TX (US); NIZAMUDEEN ISHMAEL, Pflugerville, TX (US); MANDEEP SINGH SIDHU, PFLUGERVILLE, TX (US)

Correspondence Address: STREETS & STEELE, 13831 NORTHWEST FREEWAY, SUITE 355, HOUSTON, TX, 77040, US

(21) Appl. No.: 11/462,745

(22) Filed: Aug. 7, 2006

(51) Int. Cl. H04Q 7/20

(52) U.S. Cl. 455/456.2

(57) ABSTRACT

A system and method for operating a wireless mobile communications network. A status parameter selected from signal strength and analog roam status of a wireless mobile device is provided to a second communication device in communication with the network. The communication device may select the identity of the wireless mobile device, such as by entering the telephone number of the wireless mobile device. Optionally, the wireless mobile device may control whether to upload its status parameters to the network and whether to share the status parameters with some or all other communication devices that are in communication with the network.

### BACKGROUND OF THE INVENTION

1. Field of the Invention

The present invention relates to systems and methods for managing communications between a mobile wireless communications device and another communication device.

2. Description of the Related Art

Wireless mobile communication networks handle a large volume of telephone calls every day. Consumers have widely accepted wireless mobile communication as a way of staying in touch with friends, family and businesses. Wireless mobile devices provide consumers with the security of always being able to call for information or assistance. The popularity and utility of wireless mobile devices is widely recognized.

Still, wireless mobile communication networks have limitations. First, the capacity of the network to handle large volumes of simultaneous calls is hardware limited. Additional equipment must be installed in locations that routinely experience large call volumes in order to support this level of activity. When peak demand exceeds the network capacity, a wireless mobile device can be denied service. Such peak demand may be associated with, for example, rush hour traffic or emergency situations such as hurricane evacuations.

Successful completion of any particular wireless telephone call relies upon adequate signal strength between the wireless mobile device and a base station. Signal strength is generally a function of the power of the base station and the proximity of the wireless mobile device to the station.

Still further, many current digital wireless devices also feature the ability to roam on older analog networks that typically have greater coverage than digital networks. Therefore, wireless devices with analog roaming capability can use analog networks in areas where digital service is not available, such as a rural area. While this analog roaming capability is useful in urgent situations, analog roaming has several drawbacks compared to digital service. These drawbacks include increased user expense, increased levels of radiation, lower sound quality than digital communications, and loss of certain features, such as caller-ID and data services.

When placing a call to a wireless mobile device, the calling party (“caller”) is either successful or unsuccessful in being connected with the wireless mobile device of the called party (“callee”). In the event that the call is unsuccessful, i.e., the call is not completed, the caller is typically given the option of leaving a voice mail message for the callee. While voice mail is a useful feature, it is a one-way communication that often leaves the caller with uncertainty regarding when the voice mail message will be delivered, whether the callee will be able to receive an indication that the voice mail message is available. Typically, if the callee is out of their service range, then it could be hours before the callee even knows about the call or the message so as to return the call.

Therefore, there is need for an improved system and method for providing the caller with more information about the status of the wireless mobile device of the callee. It would be desirable if the caller had some way to initially gauge callee signal strength or analog roam status prior to, or at the time of, placing a call.

### SUMMARY OF THE INVENTION

The present invention provides a method for operating a wireless mobile communications network, comprising the steps of determining a status parameter of a wireless mobile device, wherein the status parameter is selected from signal strength and analog roam status, and providing the status parameter to another communication device in communication with the network. It is preferable that the method include the step of allowing the communication device, such as a conventional telephone or another wireless mobile device, to select the identity of the desired wireless mobile device. It is also preferable for the method to include the step of allowing the wireless mobile device to control whether to upload its status parameter to the network.

In one embodiment the method further comprises the step of uploading the status parameter from the wireless mobile device to a central database of the network. Optionally, the upload timestamp is recorded in the central database in association with the status parameter. Periodic uploading of the status parameter from the wireless mobile device to a central database of the network may also be performed. In a further option, the status parameter may be uploaded using a predetermined wireless polling frequency.

In one embodiment, the method allows the wireless mobile device to authorize sharing the status parameter with the requesting communication device. A request for the status parameter of the wireless mobile device may be received from the communication device. The method then determines that the wireless mobile device has authorized sharing the status parameter with the communication device. If authorized, the requested status parameter is downloaded to the communication device, such as over a wireless data channel or a conventional public network. Optionally, the requested status parameter may be downloaded to the communication device without requiring the communication device to initiate a call to the wireless mobile device. The method may further include periodically updating the communication device with a current value of the status parameter of the wireless mobile device. In a still further option, the method may include, after the steps of determining and providing the status parameter, connecting a telephone call from the communication device to the wireless mobile device.

In a further embodiment, the method further comprises receiving a telephone call from the communication device requesting connection with the wireless mobile device, identifying the status parameters of the wireless mobile device, connecting the telephone call between the wireless mobile device and the requesting communication device if the status parameters are adequate to support the call, and playing a message to the communication device if the status parameters are not adequate to support the call.

The invention also provides a wireless communications system for connecting telephone calls between first and second wireless mobile communication devices. The system comprises a mobile service switching center having a digital memory device for storing operating status parameters of wireless mobile communication devices, a plurality of distributed transceivers in communication with the mobile service switching center, the plurality of transceivers being capable of transmitting and receiving communications with the wireless mobile device, wherein the wireless mobile device uploads a status parameter of the wireless mobile device through a transceiver to the digital memory device, and wherein the communication device downloads the status parameter of the wireless mobile device from the digital memory device through a different transceiver or conventional telephone or messaging network. In one embodiment, the status parameter is uploaded over a predetermined polling frequency that is not used for voice communications. In another embodiment, the system further comprises a database stored in the digital memory device for organizing status parameters and authorization preferences for the wireless mobile device.

The foregoing and other objects, features and advantages of the invention will be apparent from the following more particular description of a preferred embodiment of the invention, as illustrated in the accompanying drawing wherein like reference numbers represent like parts of the invention.

### BRIEF DESCRIPTION OF THE DRAWINGS

FIG. 1 is a schematic diagram of a wireless mobile communication system of the present invention.

FIG. 2 is a schematic diagram of a computer system that is suitable for storing status parameters and user authorization to share status parameters with other wireless mobile devices.

FIG. 3 is a schematic diagram of a wireless mobile device capable of communicating with the system of the present invention.

FIG. 4 is a logic diagram of a method of operating a wireless mobile communications network in accordance with the present invention.

### DETAILED DESCRIPTION

The present invention provides a method for operating a wireless mobile communications network. The network, in cooperation with at least two wireless mobile devices, provides improved communication services by sharing status parameters over the network. The preferred status parameters are signal strength and analog roam status of the callee, because sharing these parameters lets the caller know, typically before placing a call to the callee, what level of wireless service is currently available to the callee wireless mobile device. Providing a caller with callee status parameters allows the caller to use wireless communication services more wisely and conservatively.

For example, if the status parameter shared with the caller indicates that the callee has a “STRONG DIGITAL SIGNAL”, then the caller may proceed to place a call to the callee with confidence that the call should go through. If the callee does not answer, then the callee is either unavailable or on another call. However, in contrast to the prior art, the caller knows the status parameters of the callee and can form an expectation that the voice mail message will be timely communicated to the callee. Similarly, if the status parameter shared with the caller indicates that the callee has “NO SIGNAL”, then the caller could proceed to place the call, but knowing that any voice message would not be immediately deliverable. However, if the caller has an immediate need for information or simply wanted to chat briefly, then the caller may decide under the circumstances not to even place the call. These two examples illustrate how a caller is able to utilize callee status information to accurately decide to place a call when the status parameters indicate that the caller is likely to achieve her objective and avoid placing a call when the status parameters indicate otherwise.

The present disclosure discusses various embodiments that refer to a “caller” or “callee.” It should be recognized that these terms are used for convenience, but should not be taken in a limiting sense. For example, the user of a first wireless mobile device that inquires into the status parameters of another wireless mobile device may be referred to as a “caller” even though a call may not ever be completed. Similarly, the user of the wireless mobile device that is the target of the status parameter inquiry may be referred to as the “callee” even though a call may not ever be completed. However, other embodiments or discussions simply refer to first and second wireless mobile devices or, alternatively, wireless mobile devices A and B. It should be understood that these three manners of referring to two wireless mobile devices are intended to refer broadly to two wireless mobile devices operating in accordance with the present invention. Furthermore, a user or device that is referred to as a “caller” or “callee” may, at another time or during another process, take on the other role.

In accordance with the present invention, it is necessary to determine a status parameter of a first wireless mobile device, such as the signal strength, analog roam status, or both. This determination is preferably made by receiving the status parameter from the callee wireless mobile device. Optionally, the status parameter is transmitted from the callee wireless mobile device to the network in response to an interrogation transmission from the network to the callee wireless mobile device. Alternatively, the callee wireless mobile device may periodically, or upon a change in a status parameter, transmit the current status parameter to the network without interrogation. In a preferred embodiment, status parameters are communicated over a polling frequency that is different from the frequency used for voice communications. In this manner, the additional information provided by the present invention does not have to take up existing bandwidth. The frequency used for uploading status parameters from a first wireless mobile device to the network may be the same or different frequency used to download those status parameters from the network to a second wireless mobile device.

Optionally, the network may temporarily store the status parameter in a database record associated with the first wireless mobile device. Storing the status parameter(s) is preferred in embodiments where the status parameter is transmitted to the network without interrogation, so that the status parameter is available when needed. Alternatively, if the network can interrogate the first wireless mobile device and obtain the desired status parameter(s) upon demand, then database storage may not be necessary. However, even in a method involving interrogation on demand it may be preferred to store status parameters in a database in at least some circumstances, such as when the device is turned off, to reduce the use of resources to obtain the same status over and over again. The wireless mobile device may be programmed to include initial status parameter values during a wireless mobile device registration process that occurs at power up of the device and/or re-entry of the device into a coverage area of a wireless communication network. If the wireless mobile device is programmed in this manner, then network interrogations of the particular wireless mobile device can be halted when the device no longer responds and there is no need to continue interrogations until the device sends a registration transmission.

Since at least one status parameter of a first wireless mobile device (WMD) is available to the network, either in a database or upon interrogation, the network can provide this status parameter information to another WMD that is in communication with the network. In order to receive a status parameter of a callee, or potential callee, the caller device must request that the network provide the information. A caller device request may be in the form of a standing request registered with the network to periodically or continually provide the status parameters of the target device. Otherwise, a caller device request for status parameters may be transmitted to the network on demand. Still, caller device requests may be transmitted in a mixed mode in which the network periodically or continually pushes the status parameters of certain callees in a caller's “buddies list” or “contact list” and allows the caller device to make on-demand requests for status parameters of other callees that are not in the “buddies list.” For example, a caller may want continual status parameters of their family and close business associates, while only needing on-demand status parameters of a distant relative or new friend.

Regardless of the specific methods by which the network receives the status parameters of one WMD and transmits it to another communication device, the information is communicated to the caller through a display or audio signal. The caller may obtain this information is various forms. For example, the caller device may have a contact list that can be set up. A typical contact list is stored in the memory of the communication device and the contact list is acted upon by the processor in accordance with instructions provided by the operating system and inputs from the keypad and/or microphone. While a contact list typically includes a contact name, phone number and optional hands-free voice tag, the contact list of the present invention allows a communication device to select a wireless mobile device (contact), request the status parameters of the wireless mobile device (contact), and provide a display of the status parameters of the wireless mobile device (contact). The contact list and display may be accessible through a menu and, most preferably, by selecting the contact. For example, a wireless mobile device that has been setup with a contact including “John” at “1-234-567-8910” with a user-recorded voice tag, may display or announce the contact name and status parameters upon detecting the word “John” being spoken into the microphone. While detecting the word “John” would typically initiate the call with no further action, one embodiment would allow a short period of delay in which the user could read the display of status parameters and determine whether or not to continue with the call. Optionally, the user could push the “end” key or say “end” to stop the call. Alternatively, the operating system could provide desktop display indicators or icons that provide the current status parameter information for a limited number of user-flagged contacts from the contact list. However, this type of continuous display would have limited value unless the network was continually uploading and continually downloading the status parameters for the relevant contacts.

In another preferred embodiment, the wireless mobile devices allow for input and storage of user preferences, perhaps based upon a desire for privacy, such that the wireless mobile device is allowed to control whether to upload its status parameter to the network and, in a further option, which devices may receive the status parameters. Preferably, if the wireless mobile device withholds its status parameters, then a communication device requesting the status parameters of the wireless mobile device may receive a “BLOCKED” message.

The embodiments of the invention may be adapted for use with an “always on” cellular connection similar to today's broadband internet hook up. Accordingly, a user of a first wireless mobile device is able to see their customizable contact list on their cell phone and at any point immediately see the signal strength of one or more selected contacts. In one embodiment, a wireless mobile device can provide their signal strength information to the user in a heartbeat like fashion. This heartbeat can include the timestamp of when the signal strength was polled as well as the signal strength.

In another embodiment of the invention, the celled wireless mobile device may announce the status parameter in a specialized voice mail message to callers. This announcement may be provided in addition to, or instead of, downloading the status parameters to the caller's wireless mobile device. For example, a voice message might say “Hi, this is John's wireless voice mail. My signal strength is low. Please leave a message.”

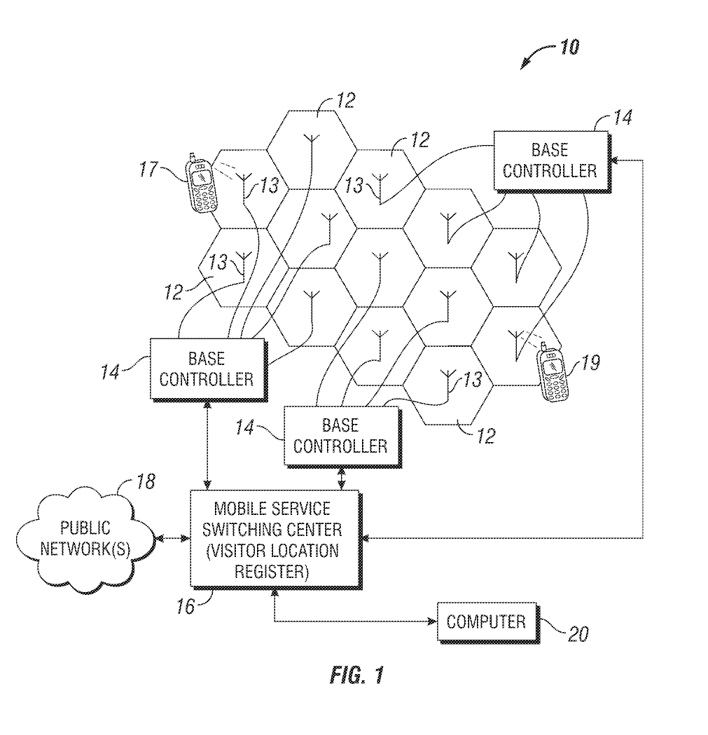

FIG. 1 is a schematic diagram of a wireless mobile communication system of the present invention. The network 10 includes a plurality of cells 12, each cell having a base station 13, where a group of base stations communicate with a base controller 14. In turn, each of the base controllers 14 is connected to a mobile service switching center 16, and the mobile service switching center 16 is further connected to other public networks 18. The mobile service switching center 16 is equipped with a computer device 20 having a database for storage of status parameters.

A first wireless mobile device 17 and second wireless mobile device 19 are shown in different locations within the network 10, which may also be within the public networks 18. Accordingly, not only can the devices 17, 19 transmit and receive voice communications, but they can upload status information, preferably using a separate polling frequency, to the closest base station 13 for communication through the base station controller 14 to the mobile service switching center 16, optionally for storage in computer 20. Similarly, the network 10 allows the devices 17, 19 to download status parameters from the mobile service switching center 16, perhaps from storage in the computer 20, through the relevant base controller 14 and closest base station 13.

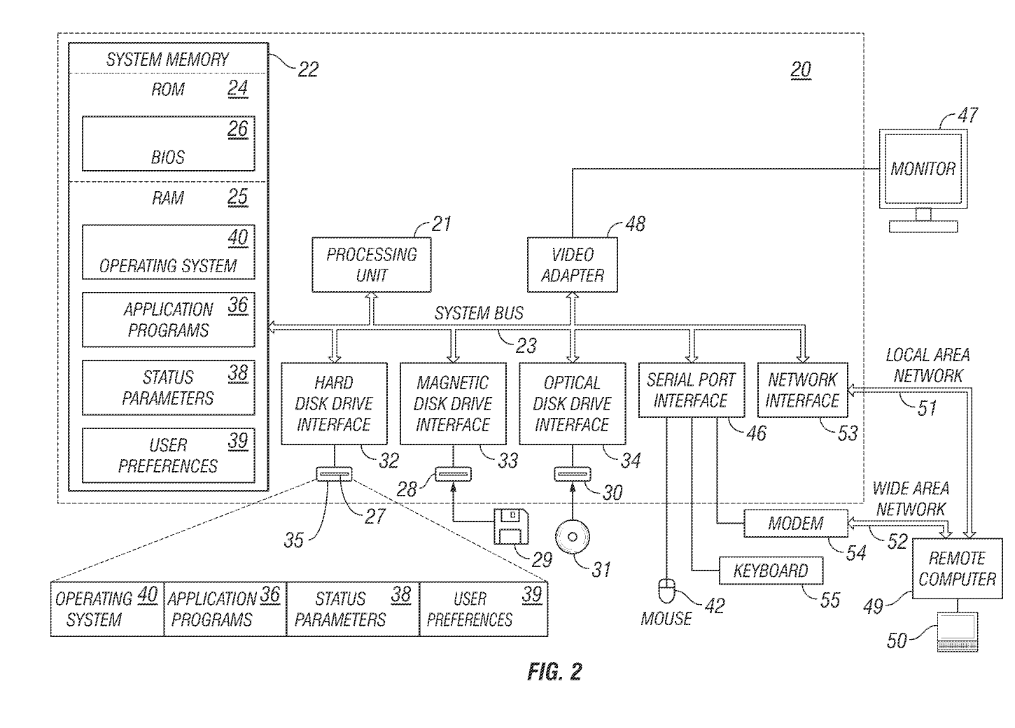

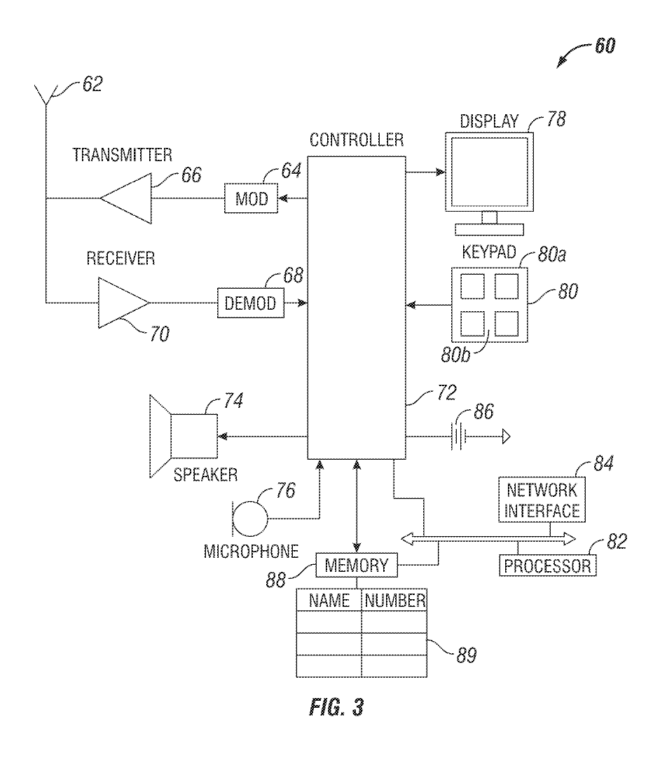

FIG. 2 is a schematic diagram of a computer system 20 that is suitable for maintaining a database of status parameters. The system 20 may be a general-purpose computing device in the form of a conventional personal computer 20. Generally, a personal computer 20 includes a processing unit 21, a system memory 22, and a system bus 23 that couples various system components including the system memory 22 to processing unit 21. System bus 23 may be any of several types of bus structures including a memory bus or memory controller, a peripheral bus, and a local bus using any of a variety of bus architectures. The system memory includes a read only memory (ROM) 24 and random access memory (RAM) 25. A basic input/output system (BIOS) 26, containing the basic routines that help to transfer information between elements within personal computer 20, such as during start-up, is stored in ROM 24.

Personal computer 20 further includes a hard disk drive 35 for reading from and writing to a hard disk 27, a magnetic disk drive 28 for reading from or writing to a removable magnetic disk 29, and an optical disk drive 30 for reading from or writing to a removable optical disk 31 such as a CD-ROM or other optical media. Hard disk drive 35, magnetic disk drive 28, and optical disk drive 30 are connected to system bus 23 by a hard disk drive interface 32, a magnetic disk drive interface 33, and an optical disk drive interface 34, respectively. Although the exemplary environment described herein employs hard disk 27, removable magnetic disk 29, and removable optical disk 31, it should be appreciated by those skilled in the art that other types of computer readable media which can store data that is accessible by a computer, such as magnetic cassettes, flash memory cards, digital video disks, Bernoulli cartridges, RAMs, ROMs, and the like, may also be used in the exemplary operating environment. The drives and their associated computer readable media provide nonvolatile storage of computer-executable instructions, data structures, program modules, and other data for personal computer 20. For example, the operating system 40 and application programs 36 may be stored in the RAM 25 and/or hard disk 27 of the personal computer 20.

A user may enter commands and information into personal computer 20 through input devices, such as a keyboard 55 and a pointing device 42. Other input devices (not shown) may include a microphone, joystick, game pad, satellite dish, scanner, or the like. These and other input devices are often connected to processing unit 22 through a serial port interface 46 that is coupled to the system bus 23, but may be connected by other interfaces, such as a parallel port, game port, a universal serial bus (USB), or the like. A display device 47 may also be connected to system bus 23 via an interface, such as a video adapter 48. In addition to the monitor, personal computers typically include other peripheral output devices (not shown), such as speakers and printers.

The personal computer 20 may operate in a networked environment using logical connections to one or more remote computers 49. Remote computer 49 may be another personal computer, a server, a client, a router, a network PC, a peer device, a mainframe, a personal digital assistant, an Internet-connected mobile telephone or other common network node. While a remote computer 49 typically includes many or all of the elements described above relative to the personal computer 20, only a memory storage device 50 has been illustrated in the figure. The logical connections depicted in the figure include a local area network (LAN) 51 and a wide area network (WAN) 52. Such networking environments are commonplace in offices, enterprise-wide computer networks, intranets, and the Internet.

When used in a LAN networking environment, the personal computer 20 is often connected to the local area network 51 through a network interface or adapter 53. When used in a WAN networking environment, the personal computer 20 typically includes a modem 54 or other means for establishing high-speed communications over WAN 52, such as the Internet. Modem 54, which may be internal or external, is connected to system bus 23 via serial port interface 46. In a networked environment, program modules depicted relative to personal computer 20, or portions thereof, may be stored in the remote memory storage device 50. It will be appreciated that the network connections shown are exemplary and other means of establishing a communications link between the computers may be used.

A number of program modules may be stored on hard disk 27, magnetic disk 29, optical disk 31, ROM 24, or RAM 25, including an operating system 40, application programs 36, the status parameter database 38 and user preferences database 39 which controls how the status parameters in database 38 may be shared. Aspects of the present invention may be implemented in the form of an application program 36 associated with status parameter database 38 that will be used in accordance with user parameters database 39. The application program 36 generally comprises computer-executable instructions for receiving and storing wireless mobile device status parameters in database 38 and providing those status parameters to other wireless mobile devices in accordance with user preferences stored in database 39.

The described example shown in FIG. 2 does not imply architectural limitations. For example, those skilled in the art will appreciate that the present invention may be implemented in other computer system configurations, including hand-held devices, multiprocessor systems, microprocessor based or programmable consumer electronics, network personal computers, minicomputers, mainframe computers, and the like. The invention may also be practiced in distributed computing environments, where tasks are performed by remote processing devices that are linked through a communications network. In a distributed computing environment, program modules may be located in both local and remote memory storage devices.

It should be recognized therefore, that embodiments of the present invention may take the form of an entirely hardware embodiment, an entirely software embodiment or an embodiment containing both hardware and software elements. In particular embodiments, including those embodiments of methods, the invention may be implemented in software, which includes but is not limited to firmware, resident software and microcode.

Furthermore, the invention can take the form of a computer program product accessible from a computer-readable medium providing program code for use by or in connection with a computer or any instruction execution system. For the purposes of this description, a computer-usable or computer readable medium can be any apparatus that can contain, store, communicate, propagate or transport the program for use by or in connection with the instruction execution system, apparatus or device.

FIG. 3 is a schematic diagram of a wireless mobile device capable of communicating with the system of the present invention. The mobile telephone or wireless mobile device 60 includes an antenna 62 for transmitting signals to and from a mobile telephone network, which is part of the communications network. The wireless mobile device 60 includes a modulator 64, a transmitter 66, a demodulator 68, a receiver 70, and a controller 72 that provides signals to the transmitter and receives signals from the receiver. These signals include audio and/or computer readable files. Also connected to the controller 72 are a conventional speaker 74, microphone 76, display 78, and input device, typically a keypad 80. The keypad includes keys 80a, which are numeric and alphanumeric keys typically found on a telephone, and other keys 80b, used for operating the mobile telephone including, but not limited to, a power key, a SEND key, and various menu scrolling and other keys. Also included is a processor 82 and a network interface 84, such as a conventional modem, and a battery power source 86.

The mobile telephone 60 also includes memory 88 that stores the values of various mobile system parameters and the number assignment module (NAM). It also stores telephone number records in a contact list or directory 89 containing contact names and telephone numbers. The database may be searched and a telephone number selected, and then automatically dialed by the mobile telephone system. The telephone operating system contains the programmed instructions to operate the telephone and the telephone's features, such as the electronic telephone directory and the directory's search and automatic dialing functions.

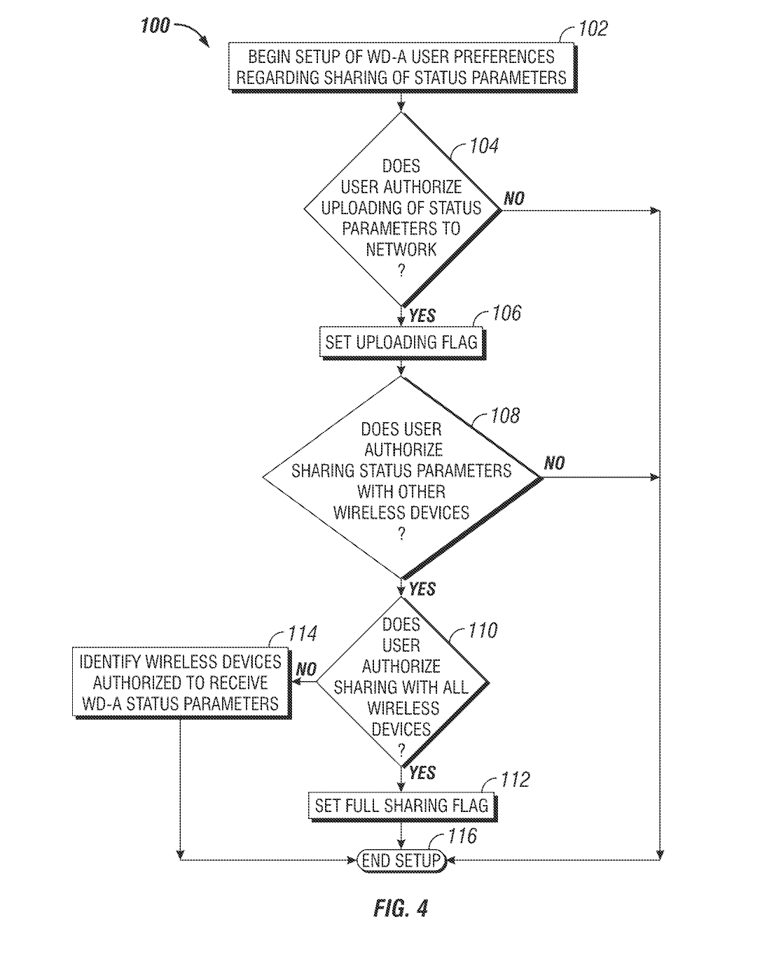

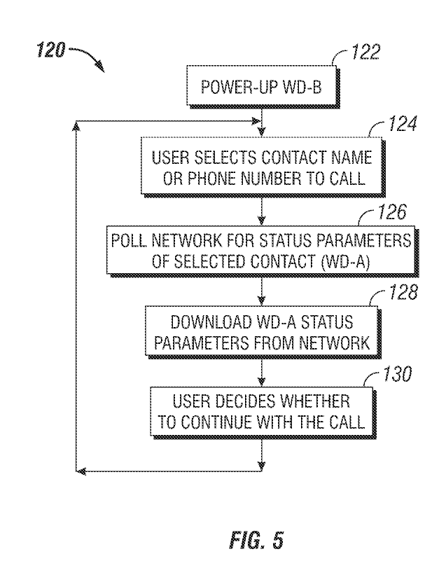

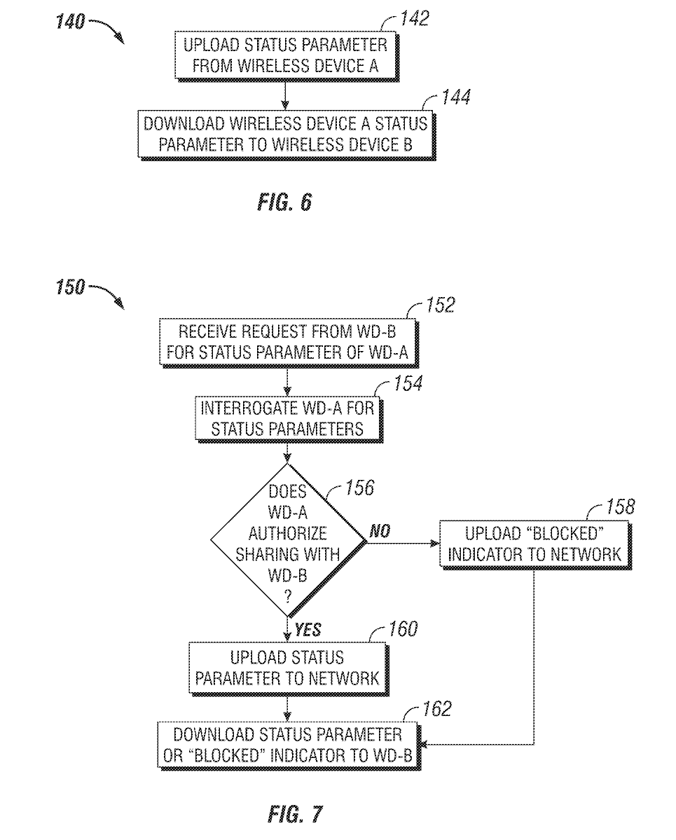

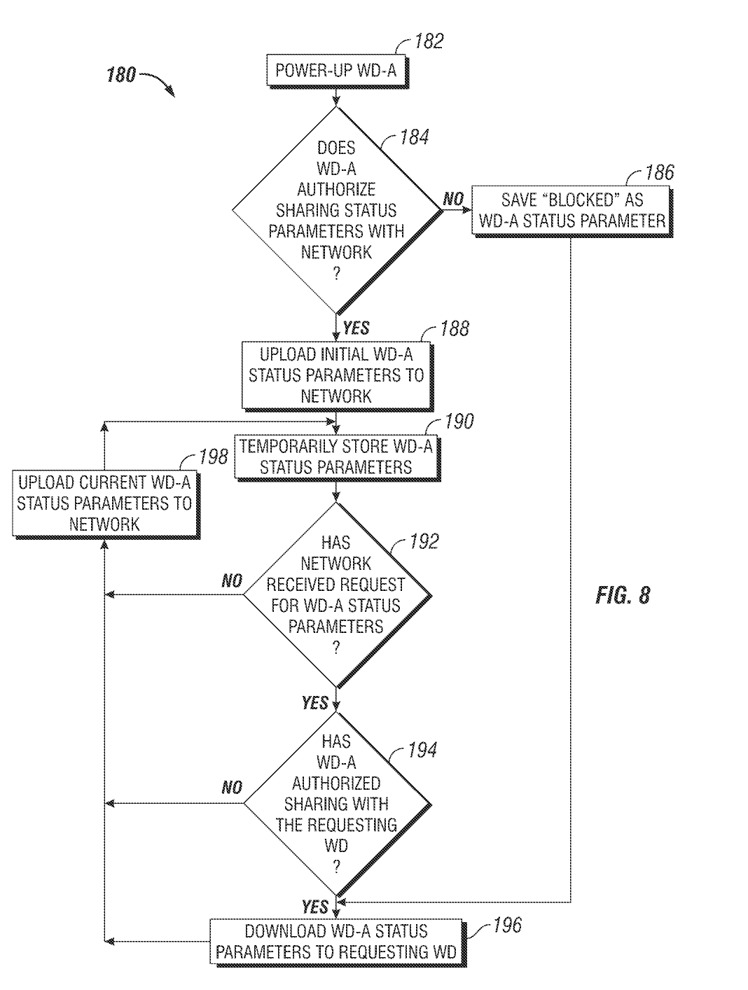

While inventive embodiments of methods are demonstrated in the following flow charts of the figures that follow, it should be realized that the demonstrated methods are exemplary methods provided by the present invention and may be implemented using computer code and/or a suitable system. It should also be recognized that FIGS. 4 through 8, and the following discussion of those Figures, describe an embodiment involving communications between two wireless mobile devices, but the invention equally encompasses the use of other communication devices that might be used to request status parameters of a wireless mobile device. Generally, the device referred to as “wireless mobile device B” or simply WD-B” may also represent other types of communication devices, such as a conventional telephone.

FIG. 4 is a logic diagram of one embodiment of a method 100 for setting up user preferences regarding sharing status parameters. In state 102, the user has elected to begin setup of user preferences in wireless mobile device A regarding sharing of status parameters. In state 104, the user enters a command indicating whether the user authorizes uploading of status parameters to the wireless communications network. If the user does not authorize uploading, then the process ends in state 116. If the user does authorize uploading, then an uploading flag is set in state 106 so that the operating system in instructed to provide uploads when requested or instructed.

Next, in state 108, the user enters a command indicating whether the user authrorizes sharing status parameters with other wireless mobile devices. If the user does not authorize sharing, then the process ends in state 116. If the user does authorize sharing, then the user is queried further in state 110 whether the user authorizes sharing with all wireless mobile devices that may request the status parameters. If the user does authorize full sharing, then a full sharing flag is set in state 112. If the user does not authorize full sharing, then in state 114 the user identifies those wireless mobile devices that are authorized to receive the user's status parameters, such as by providing the authorized devices' telephone numbers. After identifying authorized number or setting the full sharing flag, the process ends in state 116.

FIG. 5 is a logic diagram of an embodiment of a method 120 for a wireless mobile device B to obtain and use status parameters of a wireless mobile device A. In state 122, the wireless mobile device B is powered-up. In state 124, the user of wireless device B selects or enters a contact name or telephone number to call. The wireless communication network is polled or queried, in state 126, for the status parameters of the selected contact, here wireless mobile device A. In state 128, the status parameters of wireless mobile device A are downloaded from the network to the wireless device B. Having received the status parameters of wireless mobile device A, the user of device B can make an informed decision in state 130 whether to continue with the call to device A. This decision may be provided by way of entering a further command or by allowing a timeout period to pass without canceling or ending the call.

FIG. 6 is a high level logic diagram of a method 140 for operating a wireless mobile communications network in accordance with the present invention. The method includes uploading status parameters from wireless mobile device A to the network in state 142 and downloading the wireless mobile device A status parameters from the network to the wireless mobile device B in state 144. It should be recognized that the sharing of status parameters may also occur in the other direction from device B to device A. The reference to devices A and B is used for convenience of discussion, but it should be appreciated that the foregoing methods are equally applicable to any wireless mobile device that may be in communication with the network.

FIG. 7 is a logic diagram of an embodiment of a method 150 for operating a wireless mobile communications network using interrogation. The network receives a request from wireless mobile device B for the status parameters of wireless device A in state 152, then interrogates or queries wireless mobile device A for its status parameters in state 154. In state 156, it is determined whether the wireless device A has authorized sharing of status parameters with wireless device B. This determination is shown as occurring in wireless device A, but it may be preferable for device A to upload its user preferences from FIG. 4 to the network to facilitate this determination at the network level.

If device A has not authorized sharing with device B, then device A uploads a “BLOCKED” indicator to the network in state 158, or the network may provide “BLOCKED” as a default indicator unless sharing authorization is provided. If device A authorizes sharing with device B, then the status parameters are uploaded to the network in state 160, then downloaded to the device B in state 162. If sharing has not been authorized, then the “BLOCKED” indicator is downloaded to device B in state 162.

FIG. 8 is a logic diagram of one embodiment of a method 180 for operating a wireless mobile communications network using automatic periodic uploading of status parameters to the network and on-demand downloading of status parameters to an authorized requesting wireless mobile device. After wireless mobile device A powers-up in state 182, then state 184 determines whether wireless mobile device A has authorized sharing with the network. If not, then in state 186 the network saves “BLOCKED” as the wireless device A status parameters. However, if device A authorizes network sharing, then the initial status parameters of wireless device A are uploaded to the network in state 188. These status parameters are stored in a network database in state 190.

If the network receives a request for the device A status parameters in state 192, and device A has authorized sharing its status parameters with the requesting device, such as wireless mobile device B, in state 194, then the device A status parameters are downloaded to the requesting device in state 196. After downloading in state 196 or finding either that the network has received no such request in state 192 or that the request has not been authorized in state 194, then the current device A status parameters are uploaded to the network in state 198. Accordingly, device A status parameters are periodically uploaded to the network without interrogation from the network and regardless of whether the network receives any requests for the status parameters.

It will be understood from the foregoing description that various modifications and changes may be made in the preferred embodiment of the present invention without departing from its true spirit. It is intended that this description is for purposes of illustration only and should not be construed in a limiting sense. The scope of this invention should be limited only by the language of the following claims.

What is claimed is:

1. A method for operating a wireless mobile communications network, comprising:
uploading a status parameter of a wireless mobile device to the network, wherein the status parameter is selected from signal strength and analog roam status; and
downloading the status parameter from the network to a communication device in communication with the network.

2. The method of claim 1, further comprising:
allowing the communication device to select the identity of the wireless mobile device.

3. The method of claim 1, further comprising:
allowing the wireless mobile device to control whether to upload its status parameter to the network.

4. The method of claim 1, further comprising:
uploading the status parameter from the wireless mobile device to a central database of the network.

5. The method of claim 4, further comprising:
recording the upload timestamp in the central database in association with the status parameter.

6. The method of claim 1, further comprising:
periodically uploading the status parameter from the wireless mobile device to a central database of the network.

7. The method of claim 4, further comprising:
uploading the status parameter using a predetermined wireless polling frequency.

8. The method of claim 1, further comprising:
allowing the wireless mobile device to authorize sharing the status parameter with the communication device.

9. The method of claim 8, further comprising:
receiving a request from the communication device for the status parameter of the wireless mobile device.

10. The method of claim 9, further comprising:
determining that the wireless mobile device has authorized sharing the status parameter with the communication device.

11. The method of claim 10, further comprising:
downloading the requested status parameter to the communication device.

12. The method of claim 10, further comprising:
downloading the requested status parameter to the communication device over a wireless data channel.

13. The method of claim 10, further comprising:
downloading the requested status parameter to the communication device without requiring the communication device to initiate a call to the wireless mobile device.

14. The method of claim 10, further comprising:
periodically updating the communication device with a current value of the status parameter of the wireless mobile device.

15. The method of claim 1, further comprising:
receiving a telephone call from the communication device requesting connection with the wireless mobile device;
identifying the status parameters of the wireless mobile device; and
connecting the telephone call between the wireless mobile device and the communication device if the status parameters are adequate to support the call; and
playing a message to the second caller if the status parameters are not adequate to support the call.

16. The method of claim 1, further comprising:
then, after the steps of determining and providing the status parameter, connecting a telephone call from the communication device to the wireless mobile device.

17. A wireless communications system for connecting telephone calls between a wireless mobile communication device and another communication device, the system comprising:
a mobile service switching center having a digital memory device for storing an operating status parameter of a wireless mobile communication device;
a plurality of distributed transceivers in communication with the mobile service switching center, the plurality of transceivers being capable of transmitting and receiving communications with the wireless mobile device;
wherein the wireless mobile device uploads a status parameter of the wireless mobile device through a transceiver to the digital memory device; and
wherein another communication device downloads the status parameter of the wireless mobile device from the digital memory device through a different transceiver or conventional communication network.

18. The system of claim 17, wherein the status parameter is uploaded over a predetermined polling frequency that is not used for voice communications.

19. The system of claim 17, further comprising:
a database stored in the digital memory device for organizing status parameters and authorization preferences for at least the wireless mobile device.

20. The system of claim 17, wherein the communication device is a wireless mobile device.
